(19) United States
(12) Patent Application Publication
(10) Pub. No.: US 2025/0030455 A1
(43) Pub. Date: Jan. 23, 2025

(54) Electronic Wireless Transmitter to an Electronic Receiver

(71) Applicant: Reginald Keith Sapp, Clinton, MD (US)

(72) Inventor: Reginald Keith Sapp, Clinton, MD (US)

(21) Appl. No.: 18/750,803

(22) Filed: Jun. 21, 2024

(51) Int. Cl. H04B 5/24; H04B 5/22; H04B 5/79

(52) U.S. Cl. CPC H04B 5/24; H04B 5/22; H04B 5/79

(57) ABSTRACT

The Binary Transmitter and Receiver is a circuit for Binary information to travel through Air without wires.

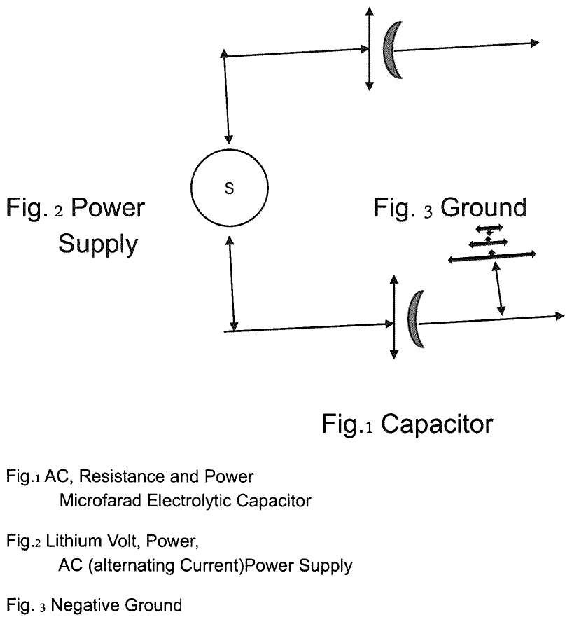

The circuit is powered as in FIG. 2 by volt, current, amp. Also powered in FIG. 1, as capacitance, and as resistance. its information is binary 0's or 1's in a series or parallel circuit or both. In FIG. 3, it has multiple grounds.

It's housed in a plastic (a polymer), tin, copper, metal or Metal alloy with keys from 0-9 key punch, A-Z and special character's key punch, and other inputs and outputs.

That uses switches, nor-gates, and-gate, diodes, resistors and compactors. Mini technology in models for mobile traveling with Lithium batteries or non-Lithium batteries for power source.

This electronic device works with controls to an analog/digital application. The device is a binary signal transmitter that uses machine binary language (A binary sinewave) to transmit it binary code to a binary receiver decoder without the use of wires between the transmitter and the receiver.

The sinewave transmitter can be AC plug in, AC ION battery or a DC to AC converter circuit at a Hertz value and 5+ volts in strength. The binary is manual pressed on the transmitter controller keypad creating a digital transfer effect.

It is configured with varies electronic components in a structure for input by pressing the keypads.

1. It was tested that a sinewave will jump it spark to another circuit. Also, we found that the use of electricity jumps across a wire without being connected to each other. The sinewave is code of binary passing through space.
It was used on a telephone from it was connection to the circuit and jumps from the circuit to the detached phone. The sinewave from the wall to the wireless phone was able to communicate through a door at a distance.
It was used component for used car parts. These components allowed for the binary code to pass through the wire. When electrical current was used, it powered up a voltage bulb at low AC amps.
